(19) United States
(12) Patent Application Publication
(10) Pub. No.: US 2026/0190037 A1
(43) Pub. Date: Jul. 2, 2026

(54) METHODS AND SYSTEMS FOR POWER CONTROL OF UPLINK TRANSMISSION

(71) Applicant: ZTE Corporation, Shenzhen (CN)

(72) Inventors: Ke YAO, Shenzhen (CN); Bo GAO, Shenzhen (CN); Yang ZHANG, Shenzhen (CN); Xiaolong GUO, Shenzhen (CN)

(21) Appl. No.: 19/544,791

(22) Filed: Feb. 19, 2026

Related U.S. Application Data
(63) Continuation of application No. PCT/CN2023/114245, filed on Aug. 22, 2023.

(51) Int. Cl. H04W 52/14; H04W 52/36

(52) U.S. Cl. CPC H04W 52/146; H04W 52/365

(57) ABSTRACT

Methods and systems for techniques for power control of uplink transmission are disclosed. In an implementation, a method of wireless communication includes determining, by a wireless device, a first-type power headroom (PHR) and a second-type PHR for a serving cell configured with both a physical uplink share channel (PUSCH) and a sounding reference signal (SRS) such that a separate power control is configured for the SRS, and providing, by the wireless device, to a network node, one or both of the first-type PHR and the second-type PHR for the serving cell in a medium access control (MAC) control element (CE).

### CROSS-REFERENCE TO RELATED APPLICATIONS

This application is a continuation and claims priority to International Application No. PCT/CN2023/114245, filed on Aug. 22, 2023, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for power control of uplink transmission.

In one aspect, a method of data communication is disclosed. The method includes determining, by a wireless device, a first-type power headroom (PHR) and a second-type PHR for a serving cell configured with both a physical uplink share channel (PUSCH) and a sounding reference signal (SRS) such that a separate power control is configured for the SR, and providing, by the wireless device, to a network node, one or both of the first-type PHR and the second-type PHR for the serving cell in a medium access control (MAC) control element (CE).

In another aspect, a method of data communication is disclosed. The method includes determining, by a wireless device, more than one second-type PHR for a serving cell configured with a sounding reference signal (SRS) such that a separate power control is configured for the SRS, and providing, by the wireless device, to a network node, the second-type PHR for the serving cell in a medium access control (MAC) control element (CE).

In another aspect, a method of data communication is disclosed. The method includes receiving, by a wireless device, from a network node, a downlink control information (DCI) including at least one transmit power control (TPC) command, determining, by the wireless device, a TPC command for a sounding reference signal (SRS) transmission, out of the at least one TPC command, according to an SRS carrier switching parameter, and determining, by the wireless device, a transmit power of the SRS transmission configured with a separate power control for SRS, according to the determined TPC command.

In another aspect, a method of data communication is disclosed. The method includes receiving, by a wireless device, from a network node, a pathloss information or a target receiving power information corresponding to a first beam state via a medium access control (MAC) control element (CE), and determining, by the wireless device, a transmit power for a transmission corresponding to the first beam state according to the pathloss information or the target receiving power information.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example network that includes one or more transmission and reception point (TRPs).

FIG. 4 shows an example of a process for wireless communication based on some example embodiments of the disclosed technology.

FIG. 5 shows another example of a process for wireless communication based on some example embodiments of the disclosed technology.

FIG. 6 shows another example of a process for wireless communication based on some example embodiments of the disclosed technology.

FIG. 7 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

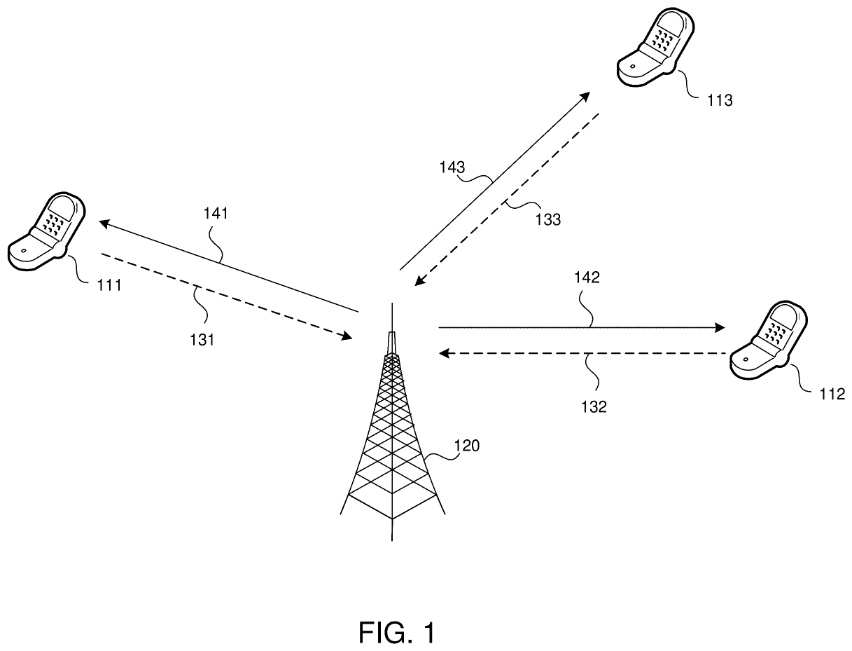

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

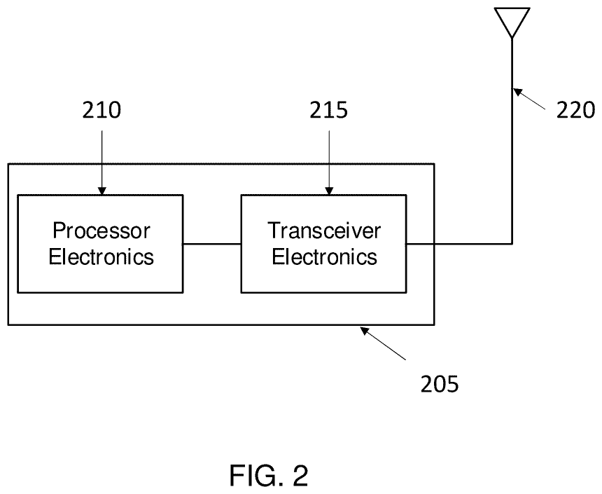

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

An enhanced MIMO scheme is becoming a key part in the fifth generation (5G) new radio (NR) technology. A heterogeneous network (HetNet) contains interconnected nodes and links of different types, and mTRP (more than one transmission and reception point (TRP)) in the HetNet is a very important example of the enhanced MIMO scheme.

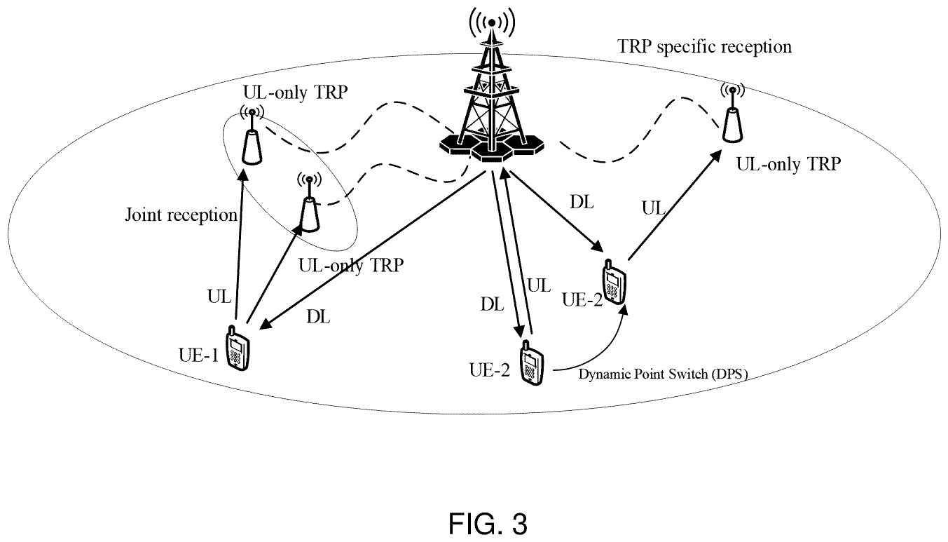

FIG. 3 shows an example network that includes one or more transmission and reception point (TRPs).

A network node (e.g., gNB) can include one or more TRPs. Some TRPs may have a higher transmit power capability, and they are referred as Macro TRPs. Some TRPs may have a lower transmit power capability, and they are referred as Micro TRPs. Some TRP can receive but cannot transmit, and they are referred as uplink (UL)-only TRPs.

In a HetNet scenario, UE connects one non-coherent joint receiving (NCJR) TRP, and/or multiple coherent joint receiving (CJR) TRPs.

Such NCJR TRP or CJR TRP can be a downlink and uplink (DL UL) TRP, such as TRP 0, or uplink only (UL only) TRP, such as TRP 1, TRP 2, etc.

The DL UL TRP can be used for an uplink (UL) for a random access channel (RACH) or uplink (UL) data of UE in cell center, and UL only TRP can be used for UL data for UE in cell edge or for load balance.

### Embodiment 1: Enhancement of Power Headroom Report (PHR) for Sounding Reference Signal (SRS) and Physical Uplink Shared Channel (PUSCH)

In some implementations, PHR is used by UE to report its available transmit power to the network node (eNodeB). The network node uses this PHR to estimate how much uplink bandwidth a UE can use.

In some implementations, PHR is determined based on an offset between a max power and a required power for an uplink transmission.

In some implementations, for uplink transmission PUSCH, the PHR is referred to as “type 1 PHR”.

In some implementations, for uplink transmission SRS, the PHR is referred to as “type 3 PHR”.

In a carrier aggregation (CA) scenario, when a PHR is triggered in one CC, PHR for all other active CCs should be reported together with the PHR for the triggered CC.

A component carrier (CC) can support 2 UL carriers (1 uplink (UL) and 1 supplement UL (SUL)), SRS and/or PUSCH can be transmitted in one or two UL carriers. One of type 1 PHR and type 3 PHR can be reported for a CC.

Issue: PHR cannot support both type 1 and type 3 in a CC in current technology.

In some embodiments of the disclosed technology, to address the issue, type 1 PHR and type 3 PHR are both allowed in a CC, since a separate SRS closed loop power control (CLPC) and PUSCH can coexist in one CC even in one UL carrier.

In some implementations, type 1 PHR and/or type 3 PHR can be indicated in one medium access control (MAC) control element (CE).

In an embodiment of the disclosed technology, 1 or 2 separate SRS type 3 PHRs are included in addition to type 1 PHR in a PHR MAC CE for a serving cell configured with both PUSCH and SRS with a separate CLPC.

In some implementations, it can be determined that type 1 or type 3 PHR is a real PHR or a virtual PHR based on whether PUSCH or SRS transmission is present or not.

In another embodiment of the disclosed technology, one of type 1 or type 3 PHR can be determined for one PHR report occasion for the serving cell configured with both PUSCH and SRS with a separate CLPC, according to at least one of the rules below:
(1) if a real type 1 PHR can be determined for the PHR reporting slot (e.g., a PUSCH transmission occasion exists in the slot), a real type 1 PHR is determined;
(2) if a real type 3 PHR can be determined for the PHR reporting slot (e.g., an SRS transmission occasion exists in the slot), a real type 3 PHR is determined;
(3) a virtual type 1 PHR or a virtual type 3 PHR is determined based on one of the following:
(a) the index of the PHR reporting slot, e.g., an even (or odd) number value of the index corresponding to a virtual type 1 PHR, an odd (or even) number value of the index corresponding to virtual type 3 PHR;
(b) a configuration or an indication from the network, e.g., only one of type 1 virtual PHR or type 3 virtual PHR is configured or indicated in a case that neither type 1 real PHR nor type 3 real PHR is determined;
(c) type 1 virtual PHR is determined, e.g., as a default; or
(d) type 3 virtual PHR is determined, e.g., as a default.
Issue: PHR cannot support two type 3 PHRs in a CC

The disclosed technology can be implemented in some embodiments to support mTRP type 3 PHR (e.g., 2 separate SRS CLPC).

A UE provides two type 3 PHRs in a slot n for serving cell c, when at least one of following conditions are met:
(1) the UE is provided with two-PHR-mode for SRS;
(2) the UE is provided with more than one SRS resource set, e.g., two SRS resource sets with usage set to ‘beamManagement’ or ‘antennaSwitching’ on active UL BWP b of carrier f of serving cell c, and the UE is provided more than one, e.g., 2 separate CLPCs for the more than one SRS resource set; or
(3) the UE is provided with more than one SRS resource, e.g., two SRS resources in an SRS resource set with usage set to ‘beamManagement’ or ‘antennaSwitching’ on active UL BWP b of carrier f of serving cell c, and the UE is provided more than one, e.g., 2, separate CLPC for the more than one SRS resource.

Among two type 3 PHRs, the first type 3 PHR is associated with the first separate CLPC for SRS, or the first SRS resource set, and the second type 3 PHR is associated with the second separate CLPC for SRS, or the second SRS resource set.

The first type 3 PHR or the second type 3 PHR can be a real PHR or a virtual PHR depending on whether or not the SRS associated with the first separate CLPC for SRS or associated with the first SRS resource set and the SRS associated with the second separate CLPC for SRS or associated with the second SRS resource set exists in slot n.

For a virtual type 3 PHR, at least one of an open loop power control (PC) parameter (e.g., target receiving power P0, factor of pathloss (PL) compensation alpha), a pathloss parameter (e.g., reference signal (RS) for pathloss measurement, PL-RS), or a closed loop PC parameter (e.g., closed loop PC index) are determined by the SRS resource set associated with the corresponding separate CLPC for SRS or associated with the first SRS resource set. For example, the first virtual type 3 PHR is associated with the first (or second) separate CLPC or associated with the first (or second) SRS resource set for SRS, then the open loop PC parameter and the pathloss parameter can be determined according to the SRS resource (set) associated with the first (or second) separate CLPC for SRS.

The first or second separate CLPC may correspond to CLPC index with 0 or 1, respectively, or other values.

Issue: For UL only TRP, one TRP is used for SRS and/or PUSCH more frequently than the other TRP, and PHRs for 2 TRP is reported with different frequencies.

The disclosed technology can be implemented in some embodiments to address this issue by determining different frequencies for 2 PHR of 2 TRP (e.g., type 1 or 3 PHR) according to at least one of the following:
(1) type 1 PHR associated with different SRS resources sets can correspond to different reporting loops;
(2) type 1 PHR associated with different SRS resources sets can correspond to different reporting periods; or
(3) type 1 PHR associated with different SRS resources sets can correspond to different triggering conditions. The triggering conditions may include: if a pathloss changes and becomes larger than a threshold value, the type 1 PHR corresponding to the pathloss is triggered.

Alternatively, there is only one PHR reporting loop setting for one type 1 PHR, and another type 1 PHR is an additional reporting that can exist in some PHR reporting occasions.

In some implementations, type 1 PHR associated with different SRS resources sets can correspond to different reporting periods. Only a timer for the reporting period of additional reporting expiration can trigger the additional PHR reporting.

In some implementations, type 3 PHR can be determined similarly based on at least one of the following:
(1) type 3 PHR associated with different indices of separate closed loop power control for SRS can correspond to different reporting loops;
(2) type 3 PHR associated with different indices of separate closed loop power control for SRS can correspond to different reporting periods; and
(3) type 3 PHR associated with different indices of separate closed loop power control for SRS can correspond to different triggering conditions. The triggering conditions may include: if a pathloss changes and becomes larger than a threshold, the type 3 PHR corresponding to the pathloss is triggered.

Alternatively, there is only one PHR reporting loop setting for one type 3 PHR, and another type 3 PHR is an additional reporting that can exist in some PHR reporting occasions.

In some implementations, type 3 PHR associated with different SRS resources sets can correspond to different reporting periods. Only a timer for the reporting period of additional reporting expiration can trigger the additional PHR reporting.

### Embodiment 2: Separate Power Control of SRS

Power control parameters of a PUSCH transmission may include an open loop power control parameter (e.g., target receiving power, P0, and/or ratio of pathloss (PL) compensation, alpha), a closed loop power control parameter (e.g., number of closed loop power control loop(s), or index of closed loop power control) and a pathloss related parameter (e.g., RS used for PL estimation). For closed loop power control, the network transmits a transmit power control (TPC) command via downlink control information (DCI) to control PUSCH transmit power.

Power control parameters of a SRS transmission may also include an open loop power control parameter, a closed loop power control parameter, and a pathloss related parameter. However, a closed loop power control (CLPC) of SRS may include an independent/separate CLPC for SRS, or shared/tied CLPC with PUSCH. For an independent CLPC for SRS, the network transmits a transmit power control (TPC) command via DCI, e.g., DCI format 2-3, to control SRS transmit power. For shared/tied CLPC with PUSCH, the network transmits a TPC command via DCI to control PUSCH transmit power, and the closed loop part of the PUSCH power can be used for SRS power control.

For a non-CA scenario, or other scenarios where SRS carrier switching is not enabled, the power control for SRS that is performed separately from PUSCH (e.g., not tied with a closed loop power control of PUSCH) may not work under the current standard.

Issue: Even for SRS with usage of beam management (BM) or antenna switching (AS), if present, a closed loop power control can only be tied with PUSCH, which is not reasonable.

In an mTRP case, TRP specific SRS may be suitable for FR2. For example,
SRS resource set 0 and/or PUSCH 0 transmitted to TRP 0 is configured with one CLPC, e.g., CLPC 0.
SRS resource set 1 and/or PUSCH 1 transmitted to TRP 1 is configured with another CLPC, e.g., CLPC 1.
TRP common SRS (aiming to both TRP 0 and TRP1) is also used in reality for simplicity, or for FR1.

Issue: TRP common SRS cannot be tied with the right PUSCH in UL-only TRP and DL/UL TRP scenario. For UL-only TRP and DL/UL TRP case, PUSCH is transmitted to UL-only TRP, but SRS is common for UL-only TRP and DL/UL TRP. Thus, the closed loop power control of TRP common SRS can only follow PUSCH. That means a TRP common SRS resource which is set to follow TPC of PUSCH 1 that aims to TRP 1, cannot be received by TRP 0 with good enough quality, because TRP 1 is closer to the UE than TRP 0.

Issue: TRP specific SRS cannot work well by using closed power control tied with corresponding TRP specific PUSCH in UL-only TRP and DL/UL TRP scenario. If PUSCH 0 is not configured or not scheduled/transmitted frequently enough, SRS for TRP 0 cannot be transmitted with a proper power.

The disclosed technology can be implemented in some embodiments to address the issues stated above, as will be discussed below.

In embodiments of the disclosed technology, a separate closed loop power control for SRS (e.g., not tied with a closed loop power control of PUSCH) should be supported for non-CA cases or other cases where SRS carrier switching is not enabled. In addition, a separate closed loop power control can be for a TRP common SRS or TRP specific SRS.

In an embodiment of the disclosed technology, assuming SRS carrier switching parameter is not provided, UE group common DCI can support independent SRS power control.

A group common DCI, e.g., DCI format 2_3, can be used for the transmission of a group of TPC commands for SRS transmissions for one or more UEs. Along with a TPC command, an SRS request may also be transmitted.

In some implementations, the following information is transmitted by using the DCI, e.g., DCI format 2_3, with CRC scrambled by TPC-SRS-RNTI: block number 1, block number 2, . . . , block number B, where B is an integer, and the starting position of a block is determined by the parameter of starting bit, e.g., startingBitOfFormat2-3 or startingBitOfFormat2-3SUL-v1530, provided by higher layers for the UE configured with the block.

If an SRS carrier switching parameter, e.g., SRS-CarrierSwitching, is not provided for a UE, for an UL (e.g., UL carrier or serving cell) without a physical uplink control channel (PUCCH) and a PUSCH or an UL (e.g., UL carrier or serving cell) on which the SRS power control is not tied with PUSCH power control, one or more blocks can be configured for the UE by higher layers where each block applies to an UL carrier (or a serving cell), with the following fields defined for each block: SRS request, which can be 0 or 2 bits; and TPC command, which can be 2 bits or other number of bits.

In some implementations, SRS carrier switching parameter, e.g., SRS-CarrierSwitching, can be configured in non-CA case, e.g., for independent SRS power control from power control of PUSCH.

The network configures the UE with either type A, e.g., typeA-SRS-TPC-PDCCH-Group, or type B, e.g., typeB-SRS-TPC-PDCCH-Group, for SRS TPC command indication in group common DCI.

Parameters for type A provide a cell configuration for SRS transmission on a PUSCH-less secondary cell (SCell), or SRS transmission with a power control that is not tied with PUSCH. For type A, a cell configuration can be provided by a list of CCs, each of which is indicated according to CC set index and CC index within a CC set index.

Parameters for type B provide a cell configuration for SRS transmission on a PUSCH-less SCell, or SRS transmission with a power control that is not tied with PUSCH. For type B, a cell configuration can be provided by a list of CCs, each of which is indicated according to a CC set index and a CC index within a CC set index, or one CC (indicated by a CC index, or the SRS carrier switching parameter configured CC) or a list of CCs, each of which is indicated according to a CC index.

One or more CC sets are determined by a UE according to the configuration of the network.

In some implementations, one or more CC sets are determined by a UE according to at least one of the rules below:
(1) All of M configured or active CCs are grouped into N CC sets based on CC indices (where M and N are positive integers);
(2) M configured or active CCs are grouped into N CC sets based on CC indices, except the SRS carrier switching parameter configured CC which is assumed as the first CC;
(3) Each CC set has same or almost same number of CCs, each of the first N−1 CC sets have ┌M/N┐ CCs, and the N-th CC set has M−(N−1)*┌M/N┐ CCs;
(4) Each CC set has same or almost same number of CCs, each of the first X CC sets have x CCs, and the last N−X CC set have x−1 CCs; or
(5) A CC set has a maximum size of CCs, e.g., 8, M configured or active CCs are grouped in N groups with the rule that the first 8 CCs according to CC indices is in first CC set, the second 8 CCs according to CC indices is in second CC set, and so on, and the remaining CCs are placed in the last CC set.

### Embodiment 3: PL Offset from gNB to UE

Issue: Generally, PL is determined for a UL transmission based on a DL RS estimation (referred to as “PL-RS”). The PL-RS should correspond to the UL transmission, e.g., the same beam pair between DL beam used for PL-RS and UL beam used for UL transmission. However, for UL-only TRP, no DL RS from UL-only TRP can be determined, and thus no proper DL RS can be used for PL estimation for the UL transmission for UL only TRP.

The disclosed technology can be implemented in some embodiments to address the issue stated above, as will be discussed below.

In some embodiments of the disclosed technology, PL for UL transmission for UL-only TRP can be determined according to an RS or a transmission corresponding to TRP 0 (e.g., DL/UL TRP). The RS or the transmission corresponding to TRP 0 may include a Msg3, a DL unified TCI state, or a configured PL-RS.

The power offset between TRP 0 and TRP 1 can be compensated by setting P0 and/or can be dynamically adjusted by TPC command for UL transmission to UL-only TRP.

In some embodiments of the disclosed technology, the offset between UL PL for TRP 0 and TRP 1 can be evaluated by the network, via the same SRS or via different SRS with the same transmit power received by DL/UL TRP and UL only TRP, and can be indicated to UE as a PL offset or a (updated) P0.

In some implementations, an indication of the PL offset or the (updated) P0 is transmitted from a network node to a UE, via a MAC CE, or a RRC signaling.

In some implementations, an indication of the PL offset or the (updated) P0 may include the following:
(1) The PL offset is associated with a UL transmission, e.g., via SRS resource indicator (SRI) for PUSCH transmission. Alternatively, the PL offset is associated with a beam state, e.g., a RS indication, a Transmission Configuration Indicator (TCI) state, an indicated TCI state for PUSCH transmission, a PUCCH transmission, or an SRS transmission. Then the PL offset value for an SRI or for a beam state can be indicated by a MAC CE or by RRC signaling. The PL offset value can also be indicated by an index from a PL offset pool/list pre-configured by RRC signaling.
(2) P0 is associated with a UL transmission, e.g., via SRI for PUSCH transmission. Alternatively, P0 can also be associated with a TCI state, e.g., an indicated TCI state for PUSCH transmission, a PUCCH transmission, or an SRS transmission. Then the P0 value for an SRI or for a beam state can be updated by a MAC CE or by RRC signaling. The P0 value can also be indicated by an index from a P0 pool/list pre-configured by RRC signaling.
(3) P0 is target receiving power, and the PL offset value can be merged into the updated P0 by the network.

The disclosed technology can be implemented in some embodiments to enhance SRS PHR.

In some implementations, both type 1 PHR and type 3 PHR or one of type 1 PHR and type 3 PHR is indicated in a MAC CE, considering a separate CLPC SRS can coexists with PUSCH in one CC.

In some implementations, mTRP type 3 PHR (2 separate SRS CLPCs), condition and mapping relation can be provided.

In some implementations, different frequencies can be provided for type 1 or 3 PHRs for 2TRP.

The disclosed technology can be implemented in some embodiments to provide a separate power control for SRS.

For non-CA case or other SRS cases where carrier switching is not enabled, a separate power control for SRS can be provided.

The indications discussed above can be indicated using DCI, or the configurations discussed above can be provided using RRC signaling.

The disclosed technology can be implemented in some embodiments to provide P0 offset from gNB to UE, e.g., as a new element in MAC CE/RRC, or as a P0 updated by MAC CE/RRC.

### Embodiment 4: Determining Power Capability for a Second-Type Transmitted Precoding Matrix Indicator (TPMI) According to First-Type TPMIs/Matrices

If a UE supports a plurality of antenna ports (transmit antennas, or transmit antenna ports), and the UE is required to transmit a transmission with at most a power level (e.g., a max transmit power, Pmax, e.g., 23 dB for power class 3 UE). In some implementations, the term “full power transmission” can be used when a transmission power can reach a max transmit power.

If there is no additional requirement, a power amplifier (PA) for an antenna port is assumed to be at a lowest level, which is 1/N max power. Here, N is the number of antenna ports that can be used to transmit a UL transmission. For a given UL transmission, not all of the UE ports are always scheduled for transmitting, e.g., only part of ports are used, and these ports are usually called non-zero power (NZP) ports, other ports are called zero power (ZP) ports. For example, an 8-Tx port UE can be scheduled to transmit a PUSCH transmission with 4 NZP ports and 4 ZP ports.

In some implementations, one or more ports of UE can support a higher capability PA than the lowest level, even when one port can support a full power transmission. Sometimes, one port cannot support a full power transmission, but a combination of portions of different ports can support a full power transmission. For example, for an 8-Tx port UE, the lowest power capability for a port is Pmax/8, but 2 ports can support higher power capability, e.g., each port supports Pmax/2, then if the PUSCH transmission is transmitted with the 2 ports as NZP ports, the transmit power can achieve Pmax, which is a full power transmission. However, other 2 ports may not reach their full power. This power capability related to a port or port group is important to scheduling PUSCH of the network. Therefore, the power capability of a UE should be reported to the network, e.g., in a case where a UE supports full power mode 2.

In some implementations, a UE reports power capability information comprising one or more first-type TPMIs.

In some implementations, a power capability (or a power scaling factor) for a second-type TPMI is determined according to the power capability information, e.g., by the UE, and/or the network.

In one example, each of the one or more first-type TPMIs can support a full power transmission if used as a precoder for a PUSCH transmission.

In one example, a second-type TPMI which has the same NZP ports as one of the one or more first-type TPMIs can support a full power transmission if used as a precoder for a PUSCH transmission. For example, the second-type TPMI may have the same or different number of MIMO layers as the first-type TPMI, but they have the same NZP ports. For example, a first TPMI is 1/\sqrt{2}[1, 0, 0, 0, 1, 0, 0, 0]^{T}, a second TPMI can be 1/\sqrt{2}[1, 0, 0, 0, 0, 0, 0, 0; 0, 0, 0, 0, 1, 0, 0, 0]^{T} which has different number of layers, or can be 1/\sqrt{2}[1, 0, 0, 0, −1, 0, 0, 0]^{T}, which has the same number layers but with different elements, such second TPMI have same NZP ports as the first TPMI, so they can support full power.

In one example, a power capability (or a power scaling factor) for a second-type TPMI can be determined according to the power capability information of the one or more first-type TPMIs with at least one of the following steps:
Step 1: Determine a first (lowest) PA capability assumption (for all ports) matrix based on the one or more first-type TPMIs/matrices according to at least one of the following criteria:
   for each first-type matrix, an element 0 is replaced by a lowest power capability scaling factor, such as 1/\sqrt{8},
   for each first-type matrix, a non-zero element is replaced by its corresponding absolute value, e.g., −1 is replaced by 1, −1/\sqrt{2} is replaced by 1/\sqrt{2}, etc.
   to determine one PA capability assumption matrix, for each port, a largest element among all the first-type TPMIs/matrices is determined, e.g., to combine two matrices into one, for each port, a larger element for this port among the two matrices is selected as the element of the PA capability assumption matrix.
Step 2: Determine PA capability for the second type of TPMI based on the determined first PA capability assumption matrix according to at least one of the following criteria:
   identify a set of NZP ports of the second-type TPMI,
   a second PA capability assumption matrix is determined as follows:
      the first PA capability assumption matrix is determined as the second PA capability assumption matrix;
      determine a lowest value of the elements of the identified set of NZP ports in the determined PA capability assumption matrix, and each element of the identified set of NZP ports of the second PA capability assumption matrix is determined as or replaced by the determined lowest value.
   determine PA capability for the second type of TPMI by a sum of square of the element for each of the identified set of NZP ports in the determined second PA capability assumption matrix.
      if the sum value is equal to or larger than 1, the second type of TPMI can support full power transmission.
      if the sum value is less than 1, the second type of TPMI cannot support full power transmission.

A UE is scheduled/triggered/configured with a UL transmission by a network. Power control (PC) parameters can be determined by the UE in a predetermined way or according to power control parameters associated with the UL transmission. UE determines a scaled power of UL transmission, e.g., PUSCH transmission, according to a power scaling factor. Then the UE determines transmit power for each port for the UL transmission based on the determined scaled power.

If the power scaling factor is equal to (or larger than) 1 for a Transmitted Precoding Matrix Indicator (TPMI), a UE can use the TPMI to transmit a PUSCH transmission at a full power. If the power scaling factor is smaller than 1 for a TPMI, that means a UE cannot use the TPMI to transmit a PUSCH transmission at a full power level.

For example, the power capability information can be one of predefined TPMI groups, such as G0, G1, . . . , Gn, (can be referred to as Gx, x can be 0, 1, . . . , n) and each of the TPMI groups includes one or more first-type TPMIs. For one UE, its PA assumption can be indicated by one or more TPMI groups.

The one or more first-type TPMIs can be representative of TPMIs/matrices, and a power capability for other TPMIs (referred to as second-type TPMIs) can be determined based on the power capability information.

The first-type TPMIs/matrices can be TPMIs from the allowed codebooks for a UE, or the first-type TPMIs/matrices can be a reference matrix that is not from the allowed codebooks for a UE, but with only one layer to represent a certain combination of NZP ports.

As shown in Table 1, each Gx includes one or more first-type matrices, each of which represents a certain combination of NZP ports.

Whether a second-type TPMI can support full power can be determined based on the one or more reported Gx.

If the second-type TPMI (or precoder) has the same NZP ports as any one of the first-type TPMIs/matrices or any combination of more than one first-type TPMI/matrix, the second-type TPMI can support a full power transmission.

In addition, whether or not the second-type TPMI having any set of NZP ports supports a full power transmission can be determined based on the one or more reported first-type TPMIs/matrices.

For example, assuming G4 in Table 1 is reported, the first-type matrices include 1/\sqrt{2}[1, 0, 0, 0, 1, 0, 0, 0]^{T}, and 1/\sqrt{2}[0, 0, 1, 0, 0, 0, 1, 0]^{T}. A second-type TPMI with any one of the following combinations of NZP ports can support a full power transmission:
ports 0, 4
ports 2, 6
Ports 0, 2, 4, 6

TABLE 1
Representative TPMI(s) for Gx for candidates of PA capability

| | PA assumption (dBm) | |
|---|---|---|
| Gx | for 8 ports | Representative TPMI(s)/matrices for 8 ports |
| G0 | (23, 14, 14, 14, | [1, 0, 0, 0, 0, 0, 0, 0]^{T} |
| | 14, 14, 14, 14) | |
| G1 | (23, 14, 14, 14, | [1, 0, 0, 0, 0, 0, 0, 0]^{T}, [0, 0, 0, 0, 1, 0, 0, 0]^{T} |
| | 23, 14, 14, 14) | |
| G2 | (20, 14, 14, 14, | 1/\sqrt{2}[1, 0, 0, 0, 1, 0, 0, 0]^{T} |
| | 20, 14, 14, 14) | |
| G3 | (23, 14, 23, 14, | [1, 0, 0, 0, 0, 0, 0, 0]^{T}, [0, 0, 0, 0, 1, 0, 0, 0]^{T}, [0, 0, 1, 0, |
| | 23, 14, 23, 14) | 0, 0, 0, 0]^{T}, [0, 0, 0, 0, 0, 0, 1, 0]^{T} |
| G4 | (20, 14, 20, 14, | 1/\sqrt{2}[1, 0, 0, 0, 1, 0, 0, 0]^{T}, 1/\sqrt{2}[0, 0, 1, 0, 0, 0, 1, 0]^{T} |
| | 20, 14, 20, 14) | |
| G5 | (17, 14, 17, 14, | 1/\sqrt{2}[1, 0, 1, 0, 1, 0, 1, 0]^{T} |
| | 17, 14, 17, 14) | |
| G6 | (20, 20, 20, 20, | 1/\sqrt{2}[1, 0, 0, 0, 1, 0, 0, 0]^{T}, 1/\sqrt{2}[0, 0, 1, 0, 0, 0, 1, 0]^{T}, |
| | 20, 20, 20, 20) | 1/\sqrt{2}[0, 1, 0, 0, 0, 1, 0, 0]^{T}, 1/\sqrt{2}[0, 0, 0, 1, 0, 0, 0, 1]^{T} |
| G7 | (17, 17, 17, 17, | 1/\sqrt{2}[1, 0, 1, 0, 1, 0, 1, 0]^{T}, 1/\sqrt{2}[0, 1, 0, 1, 0, 1, 0, 1]^{T} |
| | 17, 17, 17, 17) | |

One or more of G1-Gx can be reported from UE to gNB (network). Assuming G4 in Table 1 is reported, the first-type matrices include 1/\sqrt{2}[1, 0, 0, 0, 1, 0, 0, 0]^{T}, and 1/\sqrt{2}[0, 0, 1, 0, 0, 0, 1, 0]^{T}. A first (lowest) PA capability assumption (for all ports) matrix can be determined as: [1/\sqrt{2}, 1/\sqrt{8}, 1\sqrt{2}, 1/\sqrt{8}, 1/\sqrt{2}, 1/\sqrt{8}, 1/\sqrt{2}, 1/\sqrt{8}]^{T}.

For a second-type TPMI, such as 1/\sqrt{8}[1, 1, 0, 0, 1, 1, 0, 0], the NZP ports are port 0, port 1, port 4, and port 5. Then a lowest value of the elements of identified set of NZP ports (port 0, 1, 4, 5) in the lowest PA capability assumption matrix ([1/\sqrt{2}, 1/\sqrt{8}, 1/\sqrt{2}, 1/\sqrt{8}, 1, \sqrt{2}, 1/\sqrt{8}, 1/\sqrt{2}, 1/\sqrt{8}]^{T}) is determined as 1/\sqrt{8}. Each element of an identified set of NZP ports is determined as the determined lowest value 1/\sqrt{8}, for the second PA capability matrix, then ([1/\sqrt{8}, 1/\sqrt{8}, 1, \sqrt{2}, 1/\sqrt{8}, 1/\sqrt{8}, 1/\sqrt{2}, 1/\sqrt{8}]^{T}) is determined as the second PA capability matrix.

In one example, PA capability for the second-type TPMI may be determined by a sum of square of the determined lowest value (1/\sqrt{8}) for each of the identified set of NZP ports, and the sum is 4*(1/\sqrt{8})²=½. The sum value is less than 1, then the second-type TPMI cannot support a full power transmission.

In another example, one or more first type of TPMIs can be reported directly, instead of reported via Gx.

In another example, a (lowest) PA capability assumption (for all ports) matrix can be directly reported, e.g., via Gx, instead of one or more first-type TPMIs (matrices/precoders) reported via Gx. In other words, Gx indicates a PA capability assumption matrix, rather than one or more first-type TPMIs.

In another example, a power capability of each port or each port group can be reported from UE to the network.

For Ng=2, e.g., there are 2 port groups, each port group includes 4 ports, UE reports whether each port group supports a full power transmission independently, e.g., using 2 bits bitmap. In another example, UE reports the power capability for each port group, e.g., a power capability of each port group can be indicated by one of 1 or ½ (e.g., 1 bit for each port group).

For Ng=4, e.g., there are 4 port groups, each port group includes 2 ports, UE reports whether each port group supports a full power transmission independently, e.g., using 4 bits bitmap. In another example, UE reports the power capability for each port group, e.g., power capability of each port group can be indicated by one of 1, ½, or ¼ (e.g., 2 bits for each port group).

For Ng=8, e.g., there are 8 ports (or port groups), each port group includes 1 port, UE reports whether each port supports a full power transmission independently, e.g., using 8 bits bitmap. In another example, UE reports the power capability for each port, e.g., a power capability of each port can be indicated by one of 1, ½, ¼, or ⅛ (e.g., 2 bits for each port).

The above power capability of each port of port group can be used to determine a first PA capability assumption (for all ports) matrix. Accordingly, the power capability for any TPMI (second-type TPMI) can be determined according to the above-mentioned scheme.

For example, if only Ng=2 power capability is reported, e.g., 2-bit bitmap is “10,” the first port groups can support a full power transmission, but the second port groups cannot support a full power transmission. Assuming the first port group includes port 0, port 1, port 4, port 5, each of which can support ¼ Pmax, and the second port group includes port 2, port 3, port 6, port 7, each of which can support ⅛ Pmax which is the lowest PA capability. Accordingly, the first PA capability assumption (for all ports) matrix is determined as [1/\sqrt{4}, 1/\sqrt{4}, 1/\sqrt{8}, 1/\sqrt{8}, 1/\sqrt{4}, 1/\sqrt{4}, 1/\sqrt{8}, 1/\sqrt{8}]^{T}. For a second TPMI with NZP ports such as port 0, port 1, port 4, and port 5, it may support a full power transmission. For a second TPMI with NZP ports such as port 0 and port 1, it may not support a full power transmission. For a second TPMI with NZP ports such as port 0, 1, 4 and 5, it can support a full power transmission.

A UE can report a power capability of one or more Ngs, and the power capability of 8 ports can be derived accordingly. For example, a UE can support Ng=2, 4, 8, but can report one or more power capabilities for Ng=2, 4, or 8, e.g., only for Ng=2, but for all the 8 ports the power capability is determined accordingly. If a port group is assumed to support full power, then each port in the port group is assumed as a power capability of 1/M Pmax, where M is the number of ports in the port group. If a port group is assumed not support full power, then each port in the port group is assumed as a lowest level of power capability, e.g., ⅛ Pmax. In this way, power capability for all ports can be determined based on the power capability report, and this can be used as the first PA capability assumption matrix. Then for a given second type TPMI, a second PA capability assumption matrix can be determined in the same way as mentioned above, then the power capability for the second type TPMI can be determined.

In some implementations, a power capability of each port or each port group can be reported from UE to the network, via a Gx, or a third type TPMI. The Gx indicates one or more third type TPMI. The number of ports for the Gx or the third type TPMI corresponds to the number of port groups, such as Ng=1, 2, 4, or 8, e.g., for Ng=2, 2 ports for Gx or the third type TPMI. For example, [1, 0]^{T} is indicated via a Gx or third type TPMI. Each element in the matrix indicated by the Gx or the third type TPMI corresponding to a port group, e.g., 4 ports. All of non-zero elements indicates the corresponding NZP ports combination can support full power. For example, for Ng=2, [1, 0]^{T} indicates the first port group can support full power. Each port of the first port group can be assumed to support up to ¼ Pmax, and each port of the second port group can be assumed to support up to ⅛ Pmax; for Ng=4, [1, 0, 1, 0]^{T} indicates the first and third port groups can jointly support full power. That means four ports in the first port group and the third port group can support full power, so each port can be assumed as ¼ Pmax, and other ports can only be assumed as the lowest power capability, i.e., ⅛ Pmax. That is each port of the first and third port groups can be assumed to support up to ¼ Pmax, and each port of the second and fourth port groups can be assumed to support up to ⅛ Pmax. Then for a given second type TPMI, a second PA capability assumption matrix can be determined in the same way as mentioned above, then the power capability for the second type TPMI can be determined.

In some implementations, one or more power capability regarding to one or more Ng can be reported from a UE to a network. The power capability report can be used to determine power capability of the second type TPMI corresponding to the same Ng (for second type TPMI, and for the power capability report). For example, if a UE only reports a power capability for Ng=2, then the second type TPMI corresponding to the same Ng, i.e., Ng=2, can determine power capability based on the power capability for Ng=2.

In some implementations, the power capability report can be used to determine power capability of the second type TPMI corresponding to different Ng. For example, if a UE only reports power capability for Ng=2, then the second type TPMI corresponding to any Ng, i.e., Ng=2, 4, or 8, can determine power capability based on the power capability for Ng=2. As such, a power capability for all 8 ports can be determined based on the power capability report using the method as mentioned above.

In some implementations, power capability, PA assumption, PA capability, PA capability assumption can be replaced by each other.

In some implementations, the TPMI can be replaced by a precoder, a precoding matrix, or a matrix.

In this way, UE only reports the power capability for part of TPMI, and the power capability of any of other TPMI can be determined. It can reduce the report overhead compared to the scheme that reports a power capability for all TPMIs. It can also reduce the complexity of definition of Gx, each of Gx can only include a limited number of representative TPMIs.

In an embodiment of the disclosed technology, a power capability determination method may include: reporting, by a UE, to a network, a power capability information comprising one or more first-type TPMIs, or a power capability information corresponding to one or more ports or one or more port groups; and determining, by the UE, and/or the network, a power capability (or a power scaling factor) for a second-type TPMI according to the power capability information.

In an embodiment of the disclosed technology, a method for determining a power capability (or a power scaling factor) for a second-type TPMI according to the power capability information includes at least one of: each of the one or more first-type of TPMIs support a full power transmission; a second-type TPMI having the same NZP ports as one of the one or more first-type of TPMIs support a full power transmission; or a second-type TPMI having the same NZP ports as a combination of NZP ports of more than one first-type of TPMI can support a full power transmission.

In an embodiment of the disclosed technology, a method for determining a power capability (or a power scaling factor) for a second-type TPMI according to the power capability information includes at least one of: determining a first power capability matrix based on a power capability information comprising one or more first-type TPMIs; determining a first power capability matrix based on power capability information corresponding to one or more ports or one or more port groups; or determining a power capability for the second-type TPMI according to the determined first PA capability matrix.

In an embodiment of the disclosed technology, a method for determining a first power capability matrix based on a power capability information includes at least one of: for each first-type matrix, an element of 0 is replaced by a lowest power capability scaling factor; for each first-type matrix, a non-zero element is replaced by its corresponding absolute value; for each port, a largest element for this port among the matrices is selected as the element of the first power capability matrix.

In an embodiment of the disclosed technology, a method for determining a power capability for the second-type TPMI according to the determined first power capability matrix includes at least one of: identifying a set of NZP ports of the second-type TPMI; determining the first PA capability matrix as the second power capability matrix; determining a lowest value of the elements of the identified set of NZP ports in the determined second PA capability matrix, and replacing each element of the identified set of NZP ports of the second power capability matrix by the determined lowest value; or determining a power capability for the second-type TPMI according to the second power capability matrix.

In an embodiment of the disclosed technology, a method for determining a power capability for the second-type TPMI according to the second power capability matrix includes determining a power capability for the second-type TPMI by a sum of square of the element for each of the identified set of NZP ports in the determined second power capability matrix.

In an embodiment of the disclosed technology, a method for determining a power capability for the second-type TPMI according to the second power capability matrix further includes: if the sum value is equal to or larger than 1, the second type of TPMI can support a full power transmission; and/or if the sum value is less than 1, the second type of TPMI cannot support a full power transmission.

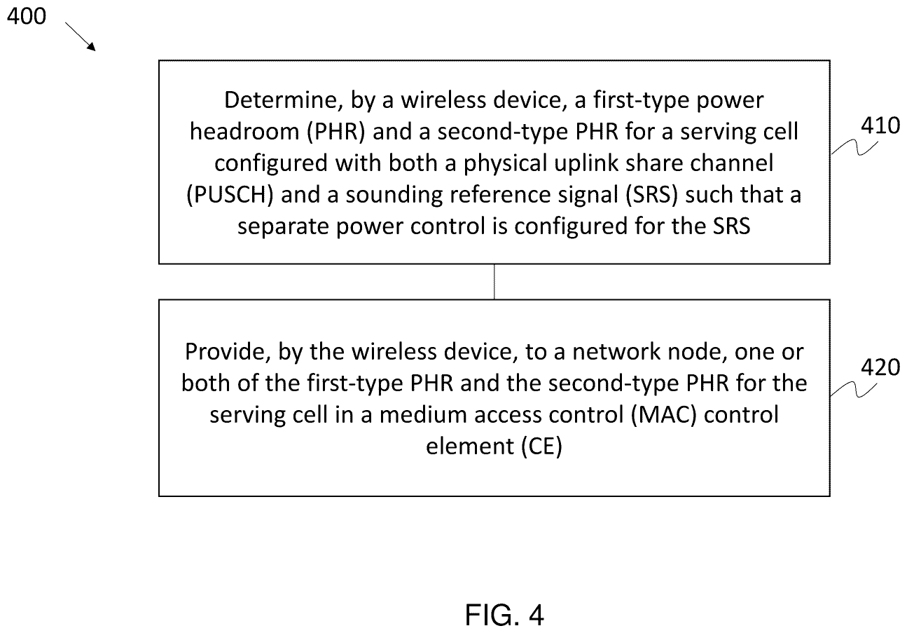

FIG. 4 shows an example of a process for wireless communication based on some example embodiments of the disclosed technology.

In some implementations, the process 400 for wireless communication may include, at 410, determining, by a wireless device, a first-type power headroom (PHR) and a second-type PHR for a serving cell configured with both a physical uplink share channel (PUSCH) and a sounding reference signal (SRS) such that a separate power control is configured for the SR, and, at 420, providing, by the wireless device, to a network node, one or both of the first-type PHR and the second-type PHR for the serving cell in a medium access control (MAC) control element (CE).

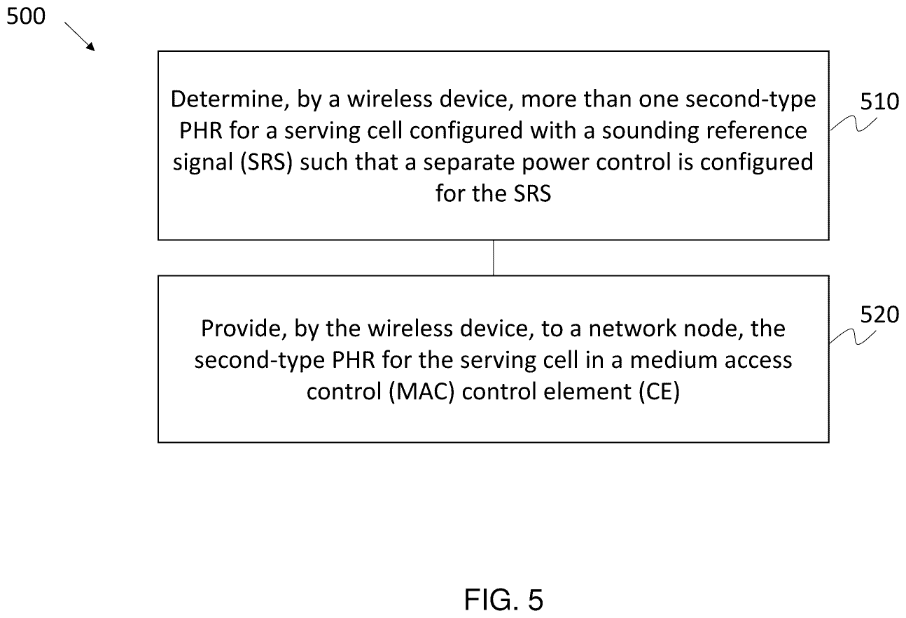

FIG. 5 shows another example of a process for wireless communication based on some example embodiments of the disclosed technology.

In some implementations, the process 500 for wireless communication may include, at 510, determining, by a wireless device, more than one second-type PHR for a serving cell configured with a sounding reference signal (SRS) such that a separate power control is configured for the SRS, and, at 520, providing, by the wireless device, to a network node, the second-type PHR for the serving cell in a medium access control (MAC) control element (CE).

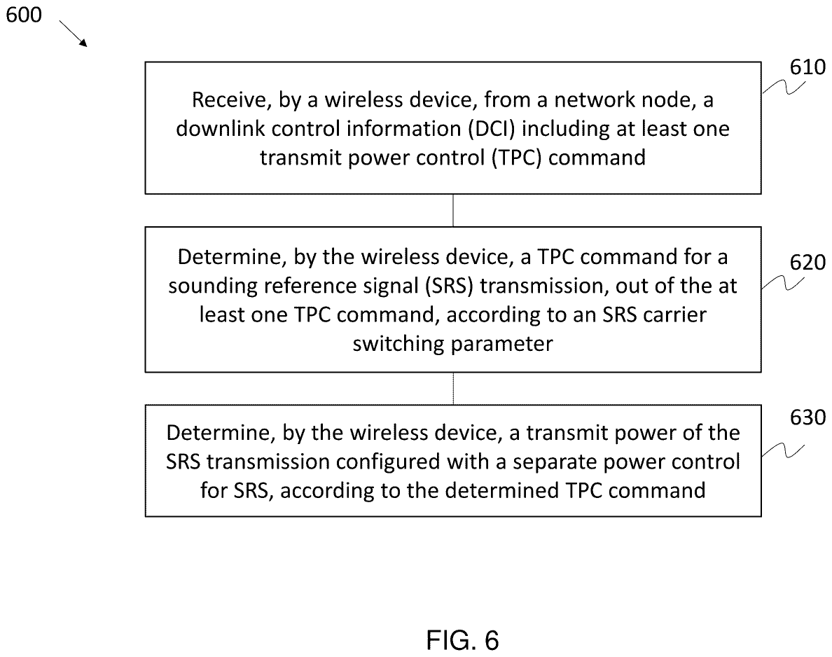

FIG. 6 shows another example of a process for wireless communication based on some example embodiments of the disclosed technology.

In some implementations, the process 600 for wireless communication may include, at 610, receiving, by a wireless device, from a network node, a downlink control information (DCI) including at least one transmit power control (TPC) command, at 620, determining, by the wireless device, a TPC command for a sounding reference signal (SRS) transmission, out of the at least one TPC command, according to an SRS carrier switching parameter, and, at 630, determining, by the wireless device, a transmit power of the SRS transmission configured with a separate power control for SRS, according to the determined TPC command.

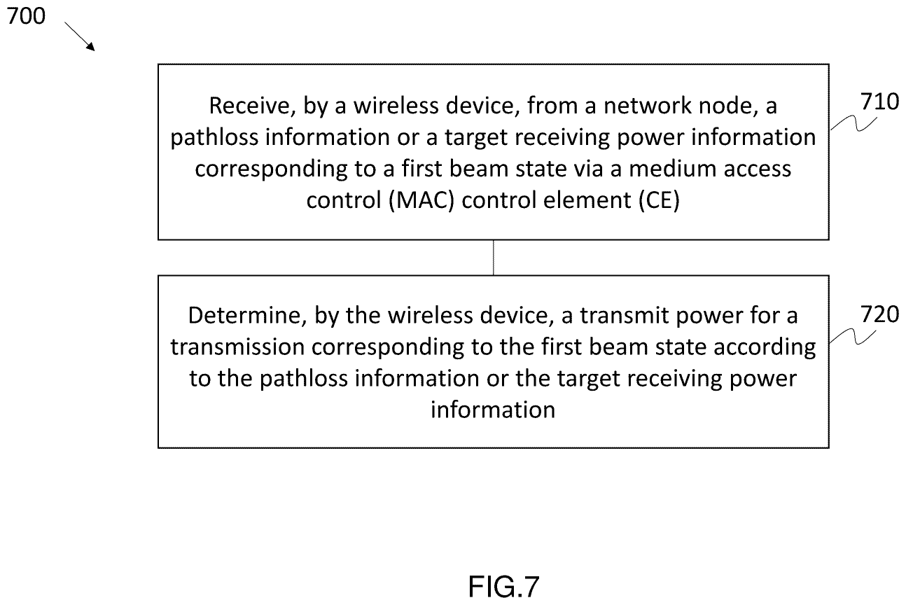

FIG. 7 shows another example of a process for wireless communication based on some example embodiments of the disclosed technology.

In some implementations, the process 700 for wireless communication may include, at 710, receiving, by a wireless device, from a network node, a pathloss information or a target receiving power information corresponding to a first beam state via a medium access control (MAC) control element (CE), and, at 720, determining, by the wireless device, a transmit power for a transmission corresponding to the first beam state according to the pathloss information or the target receiving power information.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, and that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: determining, by a wireless device, a first-type power headroom (PHR) and a second-type PHR for a serving cell configured with both a physical uplink share channel (PUSCH) and a sounding reference signal (SRS) such that a separate power control is configured for the SRS; and providing, by the wireless device, to a network node, one or both of the first-type PHR and the second-type PHR for the serving cell in a medium access control (MAC) control element (CE).

Clause 2. The method of clause 1, wherein the first-type PHR is a real PHR or a virtual PHR and the second-type PHR is a real PHR or a virtual PHR.

Clause 3. The method of any of clauses 1-2, wherein the first-type PHR includes one or more first-type PHRs.

Clause 4. The method of any of clauses 1-2, wherein the second-type PHR includes one or more second-type PHRs.

Clause 5. The method of any of clauses 1-4, wherein the first-type PHR corresponds to a PUSCH transmission or a reference PUSCH transmission.

Clause 6. The method of any of clauses 1-4, wherein the second-type PHR corresponds to an SRS transmission or a reference SRS transmission.

Clause 7. The method of any of clauses 1-6, wherein the providing the one of the first-type PHR and the second-type PHR for the serving cell in the MAC CE includes at least one of: providing a PHR that is based on a respective actual transmission in a case that either the first-type PHR or the second-type PHR is based on a respective reference transmission; providing the first-type PHR in a case that both the first-type PHR and the second-type PHR are based on respective actual transmissions or respective reference transmissions; providing the second-type PHR in a case that both the first-type PHR and the second-type PHR are based on respective actual transmissions or respective reference transmissions; providing the first-type PHR in a case that both the first-type PHR and the second-type PHR are based on respective actual transmissions or respective reference transmissions and based on a configuration or indication from the network node that the first-type PHR is prioritized; providing the second-type PHR in a case that both the first-type PHR and the second-type PHR are based on respective actual transmissions or respective reference transmissions and based on a configuration or indication from the network node that the second-type PHR is prioritized; or providing the first-type PHR or the second-type PHR in a case that both the first-type PHR and the second-type PHR are based on respective actual transmissions or respective reference transmissions and based on an index of a PHR reporting slot.

Clause 8. The method of any of clauses 1-2, wherein at least one of the first-type PHR or the second-type PHR is included in one or more type-A PHRs, wherein different type-A PHRs are provided, by the wireless device, to the network node, at different frequencies.

Clause 9. The method of clause 8, wherein the different frequencies respectively corresponding to the different type-A PHRs are determined according to one of the following conditions: type-A PHRs associated with different SRS resources sets or different closed loop power control (CLPC)s correspond to different reporting loops; type-A PHRs associated with different SRS resources sets or different CLPCs correspond to different reporting periods; or type-A PHRs associated with different SRS resources sets or different CLPCs correspond to different triggering conditions.

Clause 10. The method of clause 9, wherein the different triggering conditions include: in response to a pathloss change larger than a threshold value, the type-A PHR corresponding to the pathloss change is triggered.

Clause 11. A method of wireless communication, comprising: determining, by a wireless device, more than one second-type PHR for a serving cell configured with a sounding reference signal (SRS) such that a separate power control is configured for the SRS; and providing, by the wireless device, to a network node, the second-type PHR for the serving cell in a medium access control (MAC) control element (CE).

Clause 12. The method of clause 11, the determining the more than one second-type PHR for the serving cell configured with the SRS is performed in response to satisfying at least one of the following conditions: the wireless device is provided with a configuration indicating that more than one second-type PHR is enabled; the wireless device is provided with more than one SRS resource set using beam management or antenna switching on the serving cell; the wireless device is provided with more than one separate closed loop power control (CLPC) for the more than one SRS resource set; the wireless device is provided with more than one SRS resource in a SRS resource set using beam management or antenna switching on the serving cell; or the wireless device is provided with more than one separate closed loop power control (CLPC) for the more than one SRS resource.

Clause 13. The method of clause 12 wherein each of the more than one second-type PHR is associated with one respective separate CLPC for SRS that is associated with one respective SRS resource set or associated with one respective indicated TCI state.

Clause 14. The method of clause 12, wherein each of the more than one second-type PHR is a real PHR or a virtual PHR depending on whether the SRS corresponding to the one respective separate CLPC for SRS, or the SRS corresponding to the one respective SRS resource set, or the SRS corresponding to the one respective indicated TCI state exists in a PHR reporting slot or not.

Clause 15. The method of clause 14, wherein one of the more than one second-type PHR is a virtual PHR, and at least one of an open loop power control (PC) parameter, a pathloss parameter, or a closed loop PC parameter is determined based on the SRS resource set or the SRS resource associated with: the one respective separate CLPC for SRS; one respective SRS resource set; or one respective indicated TCI state.

Clause 16. A method of wireless communication, comprising: receiving, by a wireless device, from a network node, a downlink control information (DCI) including at least one transmit power control (TPC) command; determining, by the wireless device, a TPC command for a sounding reference signal (SRS) transmission, out of the at least one TPC command, according to an SRS carrier switching parameter; and determining, by the wireless device, a transmit power of the SRS transmission configured with a separate power control for SRS, according to the determined TPC command.

Clause 17. The method of clause 16, wherein the separate power control for SRS includes at least one of: an SRS closed loop power control that is not tied with a physical uplink shared channel (PUSCH) closed loop power control; a power control associated with separate power control adjustment states between SRS transmissions and PUSCH transmissions; an SRS power control that is not tied with the PUSCH power control; or an independent SRS power control independent of the PUSCH power control.

Clause 18. The method of clause 16, wherein the determining the TPC command for an SRS transmission according to the SRS carrier switching parameter includes: no SRS carrier switching parameter is provided to the wireless device for a serving cell or an uplink carrier corresponding to the SRS transmission; and one or more blocks are configured for the wireless device, wherein each block applies to an uplink carrier or a serving cell, with at least one of an SRS request field or a TPC command field for each block.

Clause 19. The method of clause 16, wherein the SRS carrier switching parameter is configured for a serving cell or an uplink carrier corresponding to the SRS transmission.

Clause 20. The method of clause 16, wherein the SRS carrier switching parameter is configured for a serving cell or an uplink carrier configured with separate power control for SRS.

Clause 21. The method of clause 16, wherein the SRS carrier switching parameter is configured for a serving cell or an uplink carrier in a non-carrier aggregation (CA) case.

Clause 22. The method of clause 16, wherein the wireless device is provided by the network node with a first-type parameter or a second-type parameter for SRS TPC command indication in the DCI, via the SRS carrier switching parameter.

Clause 23. The method of clause 22, wherein the first-type parameter provides a cell configuration for an SRS transmission on a PUSCH-less secondary cell (SCell), or an SRS transmission with a power control not tied with PUSCH.

Clause 24. The method of clause 22, wherein the first-type parameter provides a cell configuration including a list of component carriers (CCs) each of which is indicated according to a CC set index and a CC index within a CC set index.

Clause 25. The method of clause 22, wherein the second-type parameter provides a cell configuration for an SRS transmission on a PUSCH-less SCell, or an SRS transmission with a power control not tied with PUSCH.

Clause 26. The method of clause 22, wherein the second-type parameter provides a cell configuration including: a list of CCs, each of which is indicated according to a CC set index and a CC index within a CC set index; one CC indicated by a CC index; the SRS carrier switching parameter configured CC; or a list of CCs, each of which is indicated according to a CC index.

Clause 27. A method of wireless communication, comprising: receiving, by a wireless device, from a network node, a pathloss information or a target receiving power information corresponding to a first beam state via a medium access control (MAC) control element (CE); and determining, by the wireless device, a transmit power for a transmission corresponding to the first beam state according to the pathloss information or the target receiving power information.

Clause 28. The method of clause 27, wherein the pathloss information corresponding to the first beam state includes a pathloss value of the first beam state, or a pathloss offset value between the pathloss value of the first beam state and a pathloss value of a second beam state different from the first beam state.

Clause 29. The method of clause 27, wherein a downlink (DL) reference signal (RS) corresponding to a second beam state different from the first beam state is configured or indicated, by the network node, to the wireless device.

Clause 30. The method of clause 29, wherein the wireless device determines a downlink pathloss by measuring the DL RS corresponding to the second beam state, and determines that the downlink pathloss is a pathloss value of the second beam state.

Clause 31. The method of clause 27, wherein the network node determines an uplink pathloss by measuring an SRS resource corresponding to a second beam state different from the first beam state, and determines that the uplink pathloss is a pathloss value of the second beam state.

Clause 32. The method of clause 28, wherein no DL RS corresponding to the first beam state is configured or indicated, by the network node, to the wireless device.

Clause 33. The method of clause 28, wherein an uplink pathloss is determined by measuring an SRS resource corresponding to the first beam state, and wherein the network node determines that the uplink pathloss is the pathloss value of the first beam state.

Clause 34. The method of clause 31 or 33, wherein the SRS resource corresponding to the second beam state is same as the SRS resource corresponding to the first beam state.

Clause 35. The method of clause 31 or 33, wherein a transmit power or power control parameters of the SRS resource corresponding to the second beam state is same as a transmit power or power control parameters of the SRS resource corresponding to the first beam state.

Clause 36. The method of clause 27, wherein a pathloss value of the first beam state is indicated as the pathloss information corresponding to the first beam state, by the network node, to the wireless device.

Clause 37. The method of clause 27, wherein a pathloss offset value between a pathloss value of the first beam state and a pathloss value of a second beam state is determined by the network node, and the pathloss value of the first beam state is determined by the wireless device according to the pathloss value of the second beam state and the pathloss offset value.

Clause 38. The method of clause 27, wherein the target receiving power information corresponding to the first beam state includes a target receiving power value of the first beam state, or an offset value of a target receiving power of the first beam state.

Clause 39. The method of clause 27, wherein the wireless device determines that the target receiving power information corresponding to the first beam state is a received target receiving power value of the first beam state or a sum of a previously received target receiving power value of the first beam state and an offset value of a target receiving power of the first beam state.

Clause 40. The method of clause 27, wherein the first beam state or the second beam state includes at least one of: a quasi-co-location (QCL) information; a transmission configuration indicator (TCI) state; spatial relation information; reference signal information; spatial filter information; precoding information; transmission and reception point (TRP) information; an SRS resource set; an SRS resource indicator (SRI); or a control resource set (CORESET) pool.

Clause 41. The method of clause 40, wherein the beam state is indicated by an index of a beam state, or a codepoint index indicating one or more beam states.

Clause 42. The method of clause 27, wherein the transmission comprises at least one of a transmission of a physical uplink shared channel (PUSCH), a physical uplink control channel (PUCCH), or a sounding reference signal (SRS).

Clause 43. An apparatus for wireless communication comprising a processor that is configured to carry out the method of any of clauses 1 to 42.

Clause 44. A non-transitory computer readable medium having code stored thereon, the code when executed by a processor, causing the processor to implement a method recited in any of clauses 1 to 42.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device, from a network node, a pathloss information corresponding to a first transmission configuration indicator (TCI) state via a medium access control (MAC) control element (CE) or a Radio Resource Control (RRC) signaling;
determining, by the wireless device, a transmit power of a transmission for an uplink (UL)-only transmission and reception point (TRP) corresponding to the first TCI state according to the pathloss information, wherein the pathloss information includes a pathloss offset value between the UL-only TRP and a downlink-and-uplink (DL-and-UL) TRP; and
transmitting, by the wireless device, the transmission to the UL-only TRP of the network node.

2. The method of claim 1, wherein the pathloss information corresponding to the first TCI state includes a pathloss offset value between a pathloss value of the first TCI state and a pathloss value of a configured reference signal for pathloss measurement (PL-RS).

3. The method of claim 1, wherein a pathloss value of the first TCI state is determined by the wireless device according to a pathloss value of a configured PL-RS for pathloss measurement and the pathloss offset value.

4. The method of claim 1, wherein the first TCI state is indicated by an index of a TCI state.

5. The method of claim 1, wherein the transmission comprises at least one of a transmission of a physical uplink shared channel (PUSCH), a physical uplink control channel (PUCCH), or a sounding reference signal (SRS).

6. A method of wireless communication, comprising:
determining, by a network node, a pathloss information corresponding to a first transmission configuration indicator (TCI) state;
transmitting, by a network node, to a wireless device, the pathloss information corresponding to the first TCI state for a transmission for an uplink (UL)-only transmission and reception point (TRP) via a medium access control (MAC) control element (CE) or a Radio Resource Control (RRC) signaling, wherein the pathloss information includes a pathloss offset value between the UL-only TRP and a downlink-and-uplink (DL-and-UL) TRP; and
receiving, by a network node, the transmission via the UL-only TRP.

7. The method of claim 6, wherein the pathloss information corresponding to the first TCI state includes a pathloss offset value between a pathloss value of the first TCI state and a pathloss value of a configured reference signal for pathloss measurement (PL-RS).

8. The method of claim 7, wherein the pathloss value of the first TCI state is determined by the wireless device according to the pathloss value of the configured PL-RS and the pathloss offset value.

9. The method of claim 6, wherein the pathloss offset value is determined by the network node according to uplink pathloss values of the UL-only TRP and the DL-and-UL TRP.

10. The method of claim 6, wherein the first TCI state is indicated by an index of a TCI state.

11. The method of claim 6, wherein the transmission comprises at least one of a transmission of a physical uplink shared channel (PUSCH), a physical uplink control channel (PUCCH), or a sounding reference signal (SRS).

12. A wireless device for wireless communication comprising at least one processor that is configured to carry out a method comprising:
receiving, by a wireless device, from a network node, a pathloss information corresponding to a first transmission configuration indicator (TCI) state via a medium access control (MAC) control element (CE) or a Radio Resource Control (RRC) signaling;
determining, by the wireless device, a transmit power of a transmission for an uplink (UL)-only transmission and reception point (TRP) corresponding to the first TCI state according to the pathloss information, wherein the pathloss information includes a pathloss offset value between the UL-only TRP and a downlink-and-uplink (DL-and-UL) TRP; and
transmitting, by the wireless device, the transmission to the UL-only TRP of the network node.

13. The wireless device of claim 12, wherein the pathloss information corresponding to the first TCI state includes a pathloss offset value between a pathloss value of the first TCI state and a pathloss value of a configured reference signal for pathloss measurement (PL-RS).

14. The wireless device of claim 12, wherein a pathloss value of the first TCI state is determined by the wireless device according to a pathloss value of a configured PL-RS for pathloss measurement and the pathloss offset value.

15. The wireless device of claim 12, wherein the first TCI state is indicated by an index of a TCI state.

16. The wireless device of claim 12, wherein the transmission comprises at least one of a transmission of a physical uplink shared channel (PUSCH), a physical uplink control channel (PUCCH), or a sounding reference signal (SRS).

17. A network node comprising processor electronics and one or more memories, wherein the processor electronics is configured to execute instructions to cause the network node to implement the method recited in claim 6.
